(19) United States
(12) Patent Application Publication
(10) Pub. No.: US 2021/0219582 A1
(43) Pub. Date: Jul. 22, 2021

(54) MANUFACTURING METHOD OF KIM-CHI FLAVORING SEASONING MIX

(71) Applicant: Tae Yang AN, Seoul (KR)

(72) Inventor: Tae Yang AN, Seoul (KR)

(21) Appl. No.: 16/790,421

(22) Filed: Feb. 13, 2020

(30) Foreign Application Priority Data
Jan. 17, 2020 (KR) 10-2020-0006405

(51) Int. Cl. A23L 19/00; A23L 27/14; A23L 33/14; A23L 33/135; A23L 27/12; A23L 27/00; A23L 27/22; A23L 27/10; A23B 7/10; A23L 5/20; A23L 3/40

(52) U.S. Cl. CPC A23L 19/01; A23L 27/14; A23L 33/14; A23L 33/135; A23L 27/13; A23V 2002/00; A23L 27/22; A23L 27/105; A23B 7/10; A23L 5/20; A23L 3/40; A23L 27/88

(57) ABSTRACT

The present invention relates to a method for producing kimchi seasoning mix includes mixing the raw materials in the powder form and drying the raw materials with hot air, wherein the raw materials include red pepper powder, conventional seasoning, vegetable powder, yeast and vegetable lactic acid bacteria. Accordingly, the taste and aroma of kimchi can be felt without the process of preparing actual kimchi, such as soaking kimchi with pickled cabbage. In addition, as the process of soaking kimchi is omitted, the manufacturing process is greatly simplified. In other words, the time to soak kimchi is not only shortened, but the kimchi soup produced inevitably when actual kimchi is manufactured is omitted.

### CROSS-REFERENCE TO RELATED APPLICATIONS

This patent application claims priority under 35 U.S.C. § 119 to Korean Patent Application No. 10-2020-0006405, filed on Jan. 17, 2020, in the Korean Intellectual Property Office, the disclosure of which is incorporated by reference herein in its entirety.

### TECHNICAL FIELD

The present invention relates to a method for manufacturing a kimchi seasoning mix, and more particularly, to a method for manufacturing a kimchi seasoning mix that can provide a seasoning powder to be able to produce the natural taste of kimchi without the actual kimchi manufacturing process.

### DISCUSSION OF RELATED ART

Kimchi is Korean traditional fermented food. Kimchi is mixed and fermented from food reserves. The food reserves include edible crops from the fields, seaweed, wild vegetables, subsidiary materials, salt, salted seafood and so on. The edible crops from the fields are such as cabbage, radish, young radish, a Korean lettuce, green onion and herbs.

Kimchi is a source of various vitamins and minerals, and is rich in dietary fiber, which is known to be effective in preventing constipation and preventing adult diseases.

Kimchi is the most important food in Korea's diet, and is a representative food attracting international attention according to the globalization of Korean food. Kimchi is fermented or rancidized during distribution, and if the tissue is softened, the value of the product decreases. Therefore, the technology that can economically solve the extension of maturity period and the improvement of the sensory flavor of kimchi is the most required for enhancing the competitiveness.

Seasoning, on the other hand, adds spices and herbs for food taste. The use of seasoning stimulates flavor and aroma and promotes the secretion of each digestive gland by the stimulus of the seasoning. Thus, the seasoning increase appetite and improve digestion.

The seasoning is used during cooking food and is used during eating at the table. The seasoning contains usually salt, lemon juice, red pepper powder and white pepper. The sources of the seasoning are mainly from plants and rarely of animal origin.

Each of the seasonings is used for salty taste, bitter taste, sweet taste, sour taste, acidity taste, and fragrance, and some of them are used together. Sometimes sherry and madeira liquor are added to food after using the seasonings. To give better taste without losing taste of own food, the seasoning is selected and used in consideration of the physical and chemical properties of the food to be cooked. It is also important to determine the order, timing and quantity appropriately.

The conventional technique in which kimchi is combined with such seasoning is disclosed in Korean Patent Application No. 10-2000-0024590, filed on May 6, 2000 (hereinafter “Patent Document 1”).

Patent Document 1 relates to kimchi powder soup and a method for manufacturing the same, as a kimchi powder soup composition that can be mixed with rice or broth, kimchi seasoning (II) 0.3 to 0.6%, kimchi seasoning powder (I) 15-30%, dried kimchi flakes 1-4%, 3-9% of anchovy sauce powder, 10-15% of marinade seasoning powder, 5-20% of sodium L-glutamate, 2-6% of refined salt, 5′-soinosinate 0.05-0.5%, DL-peric acid 0.01-0.2%, lactic acid 0.1-0.5%, citric acid 0.01-0.2%, roasted sesame 5-20%, red pepper powder 3-8% and roasted layer 0.1-1.4 Consists of % (See claim 1 of Patent Document 1).

According to the conventional invention, the kimchi flavor is harmonized, and the taste of the food can be expected to be synergistic. Long term storage and distribution convenience can be expected and the food can be eaten without cooking process.

However, kimchi seasoning of Patent Literature 1 was actually prepared by drying and grinding actual kimchi. The raw kimchi was cut into 1 mm size by Silent Cutter and ground to fine grain. This kimchi was vacuum dried and pulverized to prepare kimchi seasoning powder (I). The broth of the raw kimchi was dried to provide kimchi seasoning (II). “, according to example 1 of the Invention Description of Patent Document 1. There is a problem in that it takes a long time to make seasoning, and a lot of materials are used unnecessarily.

In addition, there is a problem that the taste of seasoning also varies depending on the taste of kimchi, such as the maturation state of the kimchi is produced, it is difficult to maintain the uniformity of the taste.

### SUMMARY

The present invention has been made to solve the above problems, the problem to be solved in the present invention provides a manufacturing method of seasoning of powder form that can produce the natural taste of kimchi without separately making actual kimchi.

According to one embodiment of the present invention, a method for manufacturing Kimchi seasoning mix includes mixing raw materials in powder form and drying the raw materials in hot air. The raw materials include red pepper powder, conventional seasoning, vegetable powder, yeast and vegetable lactic acid bacteria.

A further embodiment of the present invention, the red pepper powder includes chungyang red pepper powder and Vietnamese red pepper powder.

An additional embodiment of the present invention, the conventional seasoning includes white sugar, natural salt, capsicum, citric acid, Disodium 5′-ribonucleotides and MSG.

An additional embodiment of the present invention, the vegetable powder includes garlic powder, ginger powder, kelp powder, onion powder, green onion powder, shiitake mushroom powder, paprika color and pepper powder.

An additional embodiment of the present invention, the method for manufacturing Kimchi seasoning mix may further include fermenting the mixed raw materials.

Method of producing kimchi seasoning mix according to the present invention can feel the taste and aroma of kimchi without the process of manufacturing actual kimchi, such as tossed kimchi sauce to pickled cabbage.

In addition, the manufacturing method of kimchi seasoning mix according to the present invention is greatly simplified as the process of soaking kimchi is omitted. In other words, not only the time for dipping kimchi is shortened, but the kimchi soup is omitted, which is inevitably produced when kimchi is manufactured. As the process is omitted, the drying process can also be omitted, which reduces manufacturing time and reduces costs.

In addition, the production method of kimchi seasoning mix according to the present invention can be accompanied by a variety of food. It can lead to the popularization of kimchi flavor. Especially for Koreans living abroad or foreigners who like kimchi, the taste of kimchi is made with simple sprinkling.

In addition, the production method of kimchi seasoning mix according to the present invention can be proceeded with lactic acid fermentation as the vegetable biolactic acid. The process can enhance the flavor of kimchi, and even if time passes, fermentation of acetic acid is unlikely proceeded because of a powder form. Therefore, a constant taste is maintained.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart for one embodiment of the present invention method for manufacturing a kimchi seasoning mix.

### DETAILED DESCRIPTION OF EXEMPLARY EMBODIMENTS

Hereinafter, with reference to the accompanying drawings will be described in detail an embodiment of the present invention.

As the inventive concept allows for various changes and numerous embodiments, particular embodiments will be illustrated in the drawings and described in detail in the text. However, this is not intended to limit the present invention to the specific form disclosed, it should be understood to include all modifications, equivalents, and substitutes included in the spirit and scope of the present invention.

The terminology used herein is for the purpose of describing particular embodiments only and is not intended to be limiting of the invention.

Singular expressions include plural expressions unless the context clearly indicates otherwise. In this application, the terms “comprises” or “having” are intended to indicate that there is a feature, step, component, or combination thereof described on the specification, but one or more other features, steps, components or It should be understood that they do not preclude the presence or possibility of adding these in advance.

Unless defined otherwise, all terms used herein, including technical or scientific terms, have the same meaning as commonly understood by one of ordinary skill in the art. Terms such as those defined in the commonly used dictionaries should be construed as having meanings consistent with the meanings in the context of the related art, and shall not be construed in ideal or excessively formal meanings unless expressly defined in this application.

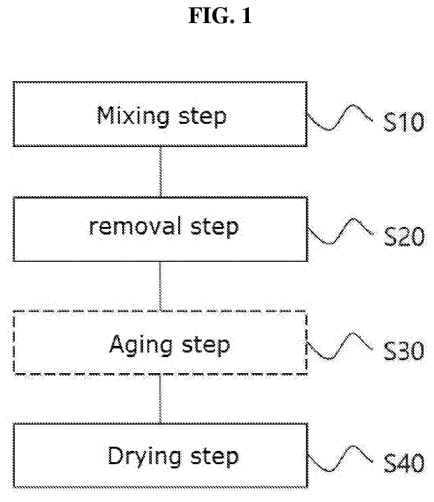

FIG. 1 is a flow chart for one embodiment of the present invention method for manufacturing a kimchi seasoning mix.

Mixing step (S10) is a step of mixing the raw materials in powder form. Mixing step (S10) is preferably to use a mixer equipment to mix a large amount of raw materials.

Raw materials include red pepper powder, conventional seasonings, vegetable powder, yeast and vegetable live lactic acid bacteria.

Red pepper powder is used for the spicy taste and color of kimchi, and uses the common red pepper powder from Korea or China. The ratio of red pepper powder contains 41 wt % to 53 wt %.

In addition, the present invention may further comprise Cheongyang red pepper powder and Vietnamese red pepper powder.

Cheongyang red pepper powder and Vietnamese red pepper powder are known to have a stronger spicy taste than common red pepper powder. This is to reduce feeling oily when adding the kimchi seasoning mix according to the present invention to foods that cause feeling like tempura.

If the seasoning mix contains more Cheongyang red pepper powder and Vietnamese red pepper powder, 11% by weight to 13% by weight of ordinary red pepper powder, 22% by weight to 28% by weight of Cheongyang red pepper powder and 8% by weight to 12% by weight of Vietnamese pepper powder.

The conventional seasoning include white sugar, natural salt, capsicum, citric acid, Disodium 5′-ribonucleotides and MSG. The conventional seasoning is the main composition of the salty, spicy and umami of kimchi.

In particular, the salt contained in the conventional seasoning serves to lower the activity of strains other than vegetable lactic acid bacteria.

The content of the conventional seasoning includes 15% to 20% by weight of white sugar, 12% to 20% by weight of natural salt, and 1.6% to 8% by weight of the mixture of capsicum, citric acid, Disodium 5′-ribonucleotides and MSG. The natural salt may be used as sun-dried salt

The vegetable powder is composed of garlic powder, ginger powder, kelp powder, onion powder, green onion powder, shiitake mushroom powder, paprika pigment, pepper powder. The vegetable powder is a component that gives off the sweet and umami flavor of kimchi. The vegetable powder is used in an appropriate amount up to 10.8% by weight to 32% by weight.

The yeast serves to deepen the taste of kimchi seasoning mix prepared according to the present invention.

The vegetable live lactic acid bacteria serves to feel the proper acidity of kimchi. The present invention has a purpose to taste the kimchi using the dried material. The present invention does not manufacture kimchi as in the conventional method and then dry it. In the manufacturing Kimchi, the key is to the taste of products generated by lactic acid fermentation of lactic acid bacteria produced through lactic acid fermentation. The present invention includes vegetable lactic acid bacteria to realize the key taste.

In addition, silicon dioxide may be further included.

The foreign substance removal step (S20) is a step of removing the foreign substances of the mixed raw materials. The foreign material removal step (S20) may filter the raw materials aggregated with the foreign material by passing the raw materials mixed in the mesh. At this time, the size of the mesh is preferably used to the size of 24 mesh. In addition, the mesh may further include a foreign material remover including a magnet to remove metal powder and so on which may be included in raw materials.

The drying step (S40) lowers the content of moisture contained in the mixed raw materials to improve the texture as seasoning, and to prevent the fermentation proceeds by yeast and vegetable lactic acid bacteria.

On the other hand, before the drying step (S40) may further proceed to the aging step (S30). The aging step (S30) serves to enhance the fermented taste of kimchi's original fermentation by allowing the lactic acid fermentation to proceed using the moisture of the mixed raw materials.

Maturation step (S30) is sealed by blocking the air to the mixed raw materials and then proceeds to aging for 2 days to 10 days at a temperature of 5˜15° C. Accordingly, the taste of the kimchi seasoning mix according to the present invention can be closer to the taste of kimchi.

### Embodiment 1

Korean red pepper powder 47 g, conventional seasoning 38.3 g, vegetable powder 21.4 g, yeast 0.5 g and lactic acid bacteria 0.5 g into a ribbon mixer, evenly mixed, and passed through a mesh containing a magnetic rod twice for removing the foreign material. And, the seasoning mix is dried for 60 minutes at a temperature of 70° C. in a hot air dryer to prepare a final kimchi seasoning mix.

### Embodiment 2

Korean red pepper powder 12 g, Cheongyang red pepper powder 25 g, Vietnamese red pepper powder 10 g, conventional seasoning 38.3 g, vegetable powder 21.4 g, yeast 0.5 g and lactic acid bacteria 0.5 g into a ribbon mixer and evenly mixed, and passed through a mesh containing a magnetic rod twice for removing the foreign material. And, the seasoning mix is dried for 60 minutes at a temperature of 70° C. in a hot air dryer to prepare a final kimchi seasoning mix.

### Embodiment 3

Korean red pepper powder 12 g, Cheongyang red pepper powder 25 g, Vietnamese red pepper powder 10 g, seasoning 38.3 g, vegetable powder 21.4 g, yeast 0.5 g and lactic acid bacteria 0.5 g into a ribbon mixer and evenly mixed, and passed through a mesh containing a magnetic rod twice for removing the foreign material. The mixture was placed in vinyl, sealed to remove air as much as possible, and aged for 5 days in a storage cell at 15° C. And, the seasoning mix is dried for 60 minutes at a temperature of 70° C. in a hot air dryer to prepare a final kimchi seasoning mix.

### Comparative Embodiment 1

Korean red pepper powder 47 g, seasoning 38.3 g, vegetable powder 21.4 g and yeast 0.5 g into a ribbon mixer, evenly mixed, and passed through a mesh containing a magnetic rod twice for removing the foreign material. And, the seasoning mix is dried for 60 minutes at a temperature of 70° C. in a hot air dryer to prepare a final kimchi seasoning mix.

### Experimental Example. Sensory Evaluation

The kimchi seasoning mix prepared as in Example was subjected to sensory evaluation as an evaluation sample.

Participants in sensory evaluation consisted of 28 women in their 30's to 50's who cooked stew and tempura directly at home with Kimchi as a resident of the metropolitan area recruited through a preliminary questionnaire.

After taking out the evaluation sample stored in the refrigerating chamber, the sample is placed at the room temperature for 20 minutes or more.

The kimchi seasoning mix of each example and the comparative example was provided to the sensory evaluation participants by 10 g, and the evaluation order of the evaluation samples was different for each participant.

The evaluation items were divided into two categories: taste characteristics evaluation and sensory characteristics evaluation.

The evaluation of the taste characteristics was carried out on a nine-point scale, including the overall taste, the flavor taste for the flavor and aroma, and the after-taste which is the taste after swallowing the samples (see Table 1).

TABLE 1

| | nine-point scale | | | | | | | | |
|---|---|---|---|---|---|---|---|---|---|
| | 1 | 2 | 3 | 4 | 5 | 6 | 7 | 8 | 9 |
| Overall/flavor | very | — | bad | — | neutral | — | good | — | very |
| taste | bad | | | | | | | | good |
| evaluation | | | | | | | | | |

In the evaluation of the sensory characteristics, the cognitive intensity of the spicy, salty, sweet, umami, and sour attributes of Kimchi Seasoning Mix was evaluated on a nine-point scale (see Table 2).

TABLE 2

| | nine-point scale | | | | | | | | |
|---|---|---|---|---|---|---|---|---|---|
| | 1 | 2 | 3 | 4 | 5 | 6 | 7 | 8 | 9 |
| sensory | very | — | bad | — | neutral | — | good | — | very |
| characteristics | bad | | | | | | | | good |
| cognitive | | | | | | | | | |
| intensity | | | | | | | | | |

The preference results showed a significant difference at 95% confidence level by a binomial test on the preference values for each example product.

Comprehensive and detailed taste and characteristic cognitive strength assessment results were obtained by the Least Significant Difference (LSD) method at the 95% confidence level.

The results are as described in Tables 3 to 5 below.

TABLE 3

| | Overall taste | Overall taste |
|---|---|---|
| Product | (frequency) | (average) |
| Embodiment 1 | 7 | 6.23 |
| Embodiment 2 | 8 | 7.56 |
| Embodiment 3 | 11 | 7.89 |
| Comparative | 2 | 5.21 |
| Embodiment 1 | | |

Overall preference was evaluated to be somewhat higher in Embodiment 3 than in Embodiment 1 and 2.

Although the general preferences of Embodiment 1 and Embodiment 2 are almost no difference, it can be seen that the overall preference is somewhat different.

In Comparative Embodiment 1, it can be seen that it is the lowest level in the general preference. (95% confidence level).

TABLE 4

| Product | Flavor taste | After-taste |
|---|---|---|
| Embodiment 1 | 7.21 | 6.29 |
| Embodiment 2 | 7.14 | 6.87 |
| Embodiment 3 | 6.97 | 7.11 |
| Comparative | 7.21 | 6.67 |
| Embodiment 1 | | |

Both the Embodiments and the Comparative Embodiment do not show a significant difference in flavor taste and after-taste.

TABLE 5

| Product | Spicy | Salty | Sweet | Umami | Sour |
|---|---|---|---|---|---|
| Embodiment 1 | 6.27 | 7.12 | 3.14 | 5.24 | 2.94 |
| Embodiment 2 | 7.85 | 6.89 | 3.24 | 5.61 | 3.05 |
| Embodiment 3 | 7.23 | 6.47 | 3.57 | 4.98 | 4.09 |
| Comparative | 6.47 | 7.01 | 3.41 | 5.11 | 2.89 |
| Embodiment 1 | | | | | |

It can be seen that Embodiment 2 shows the most excellent level with the spicy taste, and the Embodiment 3 shows the most excellent level with sour taste. It can be deduced that the Embodiment 2 and 3 are the closest to the Kimchi taste.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed:

1. A method for manufacturing Kimchi seasoning mix comprises:
mixing raw materials in powder form; and
drying the raw materials in hot air,
wherein the raw materials include red pepper powder, conventional seasoning, vegetable powder, yeast and vegetable lactic acid bacteria.

2. The method of claim 1,
wherein the red pepper powder includes chungyang red pepper powder and Vietnamese red pepper powder

3. The method of claim 1,
wherein the conventional seasoning includes white sugar, natural salt, capsicum, citric acid, Disodium 5′-ribonucleotides and MSG.

4. The method of claim 1,
wherein the vegetable powder includes garlic powder, ginger powder, kelp powder, onion powder, green onion powder, shiitake mushroom powder, paprika color and pepper powder.

5. The method of claim 1, may further comprising:
fermenting the mixed raw materials.
